(19) United States
(12) Patent Application Publication
(10) Pub. No.: US 2020/0380190 A1
(43) Pub. Date: Dec. 3, 2020

(54) DESIGN ASSISTANCE SYSTEM, DESIGN ASSISTANCE METHOD, AND PROGRAM RECORDING MEDIUM

(71) Applicant: NEC Corporation, Minato-ku, Tokyo (JP)

(72) Inventors: Ryusuke NEBASHI, Tokyo (JP); Toshitsugu SAKAMOTO, Tokyo (JP); Makoto MIYAMURA, Tokyo (JP); Yukihide TSUJI, Tokyo (JP); Ayuka TADA, Tokyo (JP); Xu BAI, Tokyo (JP)

(73) Assignee: NEC Corporation, Minato-ku, Tokyo (JP)

(21) Appl. No.: 16/766,467

(22) PCT Filed: Nov. 21, 2018
(86) PCT No.: PCT/JP2018/042926

§ 371 Date: May 22, 2020

(30) Foreign Application Priority Data
Nov. 29, 2017 (JP) 2017-228490

(51) Int. Cl. G06F 30/343; G06F 30/347

(52) U.S. Cl. CPC G06F 30/343; G06F 2119/22; G06F 30/347

(57) ABSTRACT

A design assistance system including: a logic synthesis unit that receives input of an operation description file of the programmable logic integrated circuit, logically synthesizes the inputted operation description file, and generates a net list by using logic elements included in the programmable logic integrated circuit; an arrangement wiring unit that generates resource information of the programmable logic integrated circuit, arranges the logic elements included in the net list on the basis of the generated resource information, and virtually generates a signal path by laying wires among the arranged logic elements; and a reliability control unit that generates configuration information of the programmable logic integrated circuit on the basis of at least two reliability modes, and outputs the generated configuration information.

### TECHNICAL FIELD

The present invention relates to a design assistance system, a design assistance method, and a program that assist circuit design of a programmable logic integrated circuit.

### BACKGROUND ART

A programmable logic integrated circuit such as a field programmable gate array (FPGA) is constituted of a logic element, an input/output element, and a connection element. The logic element provides a programmable logic operation function. A logic block constituted of, for example, a lookup table achieving a combination circuit, a flip-flop storing data, and a selector is used as the logic element. The input/output element provides a programmable input/output function between a device and an outside. The connection element provides a programmable connection function between the logic element and the input/output element. A user optionally combines a plurality of logic blocks and thereby can form a desired logic circuit in a programmable logic integrated circuit.

Information necessary for forming a desired logic circuit is referred to as configuration information and is stored on a memory element included in the programmable logic integrated circuit. As a memory element storing configuration information, a static random access memory (SRAM) cell, a floating-gate metal-oxide-semiconductor (MOS) transistor, or the like is used.

In general, a switch connecting the above-described memory element and logic block in a modifiable manner is formed on the same layer as a logic block constituted of a large number of transistors, thereby becoming a cause of increasing an area overhead. As a chip area of a programmable logic integrated circuit is large, a production cost increases. As a layout area of a memory element and a switch is large, a ratio of a logic block to a chip area decreases.

Therefore, as a switch enabling connection between logic blocks after production to be modifiable while suppressing an increase in a layout area, a programmable logic integrated circuit using a resistance change element has been proposed. For connection and disconnection of wiring in a general programmable logic integrated circuit, an SRAM cell being a memory element and a switch cell including one transistor provided with a switch function are used. In contrast, the resistance change element includes both of a memory function and a switch function, and therefore a switch cell can be achieved by one resistance change element. Therefore, a programmable logic integrated circuit using a resistance change element can be miniaturized, compared with a programmable logic integrated circuit using an SRAM cell and a switch cell.

PTL 1, PTL 2, and NPL 1 disclose a programmable logic integrated circuit using a resistance change element. The programmable logic integrated circuit disclosed in PTL 1, PTL 2, and NPL 1 has a configuration in which a resistance change element including a solid electrolyte material containing metallic ions is arranged between a first wiring layer and a second wiring layer formed on top of the first wiring layer. The resistance change element changes a resistance value by applying bias voltage in a forward direction or a backward direction and functions as a switch for electrically connecting or disconnecting the first wiring and the second wiring. Regarding a resistance value of a resistance change element, for example, a ratio between a low resistance state (ON-state) and a high resistance state (OFF-state) is the 5th power of 10 or more. An ON- or OFF-state of a resistance change element is maintained even when power supply to a programmable logic integrated circuit is stopped, and therefore time and effort for loading configuration information at each power-on can be saved.

In a semiconductor device described in PTL 1, a resistance change element is arranged in each intersection of a first wiring group and a second wiring group intersecting with the first wiring group. Therefore, according to the device of PTL1, a size of a crossbar switch capable of connecting or disconnecting any wiring of the first wiring group and any wiring of the second wiring group can be reduced. In other words, according to the device of PTL 1, an increase in performance of a programmable logic integrated circuit by large reduction of a chip area and improvement of usage efficiency of a logic block is expected.

FIG. 23 is one example of the crossbar switch of PTL 1 (hereinafter, referred to as a crossbar circuit 100). The crossbar circuit 100 in FIG. 23 has a configuration in which a resistance change element 110 is arranged in each position where a plurality of first wirings 121 to 126 and a plurality of second wirings 131 to 136 intersect with each other. In FIG. 23, a resistance change element 110 of an ON-state is indicated by being blacked out and a resistance change element 110 of an OFF-state is indicated by being outlined. The crossbar circuit 100 in FIG. 23 indicates a state of being wire-connected as a crossbar, by causing a plurality of resistance change elements 110 located on a diagonal line to be in an ON-state.

FIG. 24 is one example of the crossbar switch of PTL 2 (hereinafter, referred to as a crossbar circuit 200). The crossbar circuit 200 in FIG. 24 has a configuration in which a unit element 210 configured by connecting two resistance change elements in series is arranged in each position where a plurality of first wirings 221 to 226 and a plurality of second wirings 231 to 236 intersect with each other. In FIG. 24, an element of an ON-state is indicated by being blacked out and an element of an OFF-state is indicated by being outlined. The crossbar circuit 200 in FIG. 24 causes both of two resistance change elements constituting the unit element 210 to be in an ON-state and thereby causes the unit element 210 to be in an ON-state, and causes both of two resistance change elements to be in an OFF-state and thereby causes the unit element 210 to be in an OFF-state. The crossbar circuit 200 in FIG. 24 indicates a state of being wire-connected as a crossbar, by causing a plurality of unit elements 210 located on a diagonal line to be in an ON-state.

### CITATION LIST

### Patent Literature

[PTL 1] Japanese Patent No. 4356542
[PTL 2] International Publication No. WO 2012/043502

### Non Patent Literature

[NPL 1] M. Miyamura, et al., “Low-power programmable-logic cell arrays using nonvolatile complementary atom switch”, 15th International Symposium on Quality Electronic Design (ISQED), pp. 330 to 334, 2014

### SUMMARY OF INVENTION

### Technical Problem

FIG. 25 illustrates a state where, in the crossbar circuit 100 in FIG. 23, an open defect of one bit occurs in a resistance change element 110 located in an intersection of a first wiring 123 and a second wiring 133. When an open defect as in FIG. 25 occurs, input from the first wiring 123 is not transmitted to output of the second wiring 133. FIG. 26 illustrates a state where, in the crossbar circuit 100 in FIG. 23, a short-circuit defect of one bit is mixed in a resistance change element 110 located in an intersection of a first wiring 125 and a second wiring 133. When a short-circuit defect as in FIG. 26 occurs, input from a first wiring 123 and input from the first wiring 125 collide with each other and output from the second wiring 133 and output from a second wiring 135 are unstable.

FIG. 27 illustrates a state where, in the crossbar circuit 200 in FIG. 24, an open defect of one bit occurs in a unit element 210 located in an intersection of a first wiring 223 and a second wiring 233. Occurrence of an open defect as in FIG. 27 leads to a malfunction of a circuit. FIG. 28 illustrates a state where, in the crossbar circuit 200 in FIG. 24, a short-circuit defect of one bit is mixed in a unit element 210 located in an intersection of a first wiring 225 and a second wiring 233. When a short-circuit defect as in FIG. 28 occurs, a circuit operation of the crossbar circuit 200 is not affected.

In other words, in a crossbar circuit in which a resistance change element of PTL1 and PTL2 is arranged, when a defect of one bit occurs in a resistance change element constituting a crossbar switch, a desired operation may not be always provided.

A resistance change element of PTLs 1 and 2 may degrade due to repetition of rewriting, and therefore the number of rewritable times is limited. When writing is concentrated in some of resistance change elements, these elements early degrade and then it may be difficult to form a desired logic circuit.

An object of the present invention is to provide, in order to solve the above-described problems, a design assistance system capable of designing a highly reliable programmable logic integrated circuit.

### Solution to Problem

A design assistance system according to one aspect of the present invention includes: a logic synthesis unit that logically synthesizes, by using, as input, an operation description file of a programmable logic integrated circuit, the input operation description file and generates a net list by using logic elements included in the programmable logic integrated circuit; an arrangement wiring unit that generates resource information of the programmable logic integrated circuit, arranges, based on the generated resource information, the logic elements included in the net list, and virtually generates a signal path by wiring the arranged logic elements; and a reliability control unit that generates, based on at least two reliability modes, configuration information of the programmable logic integrated circuit and outputs the generated configuration information.

A design assistance method according to one aspect of the present invention includes: logically synthesizing an operation description file of a programmable logic integrated circuit; generating a net list by using logic elements included in the programmable logic integrated circuit; generating resource information of the programmable logic integrated circuit; arranging, based on the generated resource information, the logic elements included in the net list; virtually generating a signal path by wiring the arranged logic elements; generating, based on at least two reliability modes, configuration information of the programmable logic integrated circuit; and outputting the generated configuration information.

A program according to one aspect of the present invention causes a computer to execute: processing of logically synthesizing an input operation description file of a programmable logic integrated circuit; processing of generating a net list by using logic elements included in the programmable logic integrated circuit; processing of generating resource information of the programmable logic integrated circuit; processing of arranging, based on the generated resource information, the logic elements included in the net list; processing of virtually generating at least one signal path by wiring the arranged logic elements; processing of generating, based on at least two reliability modes, configuration information of the programmable logic integrated circuit; and processing of outputting the generated configuration information.

### Advantageous Effects of Invention

According to the present invention, a design assistance system capable of designing a highly reliable programmable logic integrated circuit can be provided.

### BRIEF DESCRIPTION OF DRAWINGS

FIG. 1 is a block diagram illustrating a configuration of a design assistance system according to a first example embodiment of the present invention.

FIG. 2 is a block diagram illustrating one configuration example of a design assistance tool group included in the design assistance system according to the first example embodiment of the present invention.

FIG. 3 is a flowchart for illustrating an operation of the design assistance system according to the first example embodiment of the present invention.

FIG. 4 is a flowchart for illustrating arrangement wiring processing based on the design assistance system according to the first example embodiment of the present invention.

FIG. 5 is a flowchart for illustrating reliability control processing based on the design assistance system according to the first example embodiment of the present invention.

FIG. 6 is a schematic diagram illustrating one example of two logic blocks included in a programmable logic integrated circuit and a routing resource connecting these logic blocks to be designed by the design assistance system according to the first example embodiment of the present invention.

FIG. 7 is a schematic diagram illustrating a first example of a switch resource included in a programmable logic integrated circuit to be designed by the design assistance system according to the first example embodiment of the present invention.

FIG. 8 is a schematic diagram illustrating a second example of a switch resource included in a programmable logic integrated circuit to be designed by the design assistance system according to the first example embodiment of the present invention.

FIG. 9 is a schematic diagram illustrating a third example of a switch resource included in a programmable logic integrated circuit to be designed by the design assistance system according to the first example embodiment of the present invention.

FIG. 10 is a schematic diagram illustrating a fourth example of a switch resource included in a programmable logic integrated circuit to be designed by the design assistance system according to the first example embodiment of the present invention.

FIG. 11 is a schematic diagram illustrating a fifth example of a switch resource included in a programmable logic integrated circuit to be designed by the design assistance system according to the first example embodiment of the present invention.

FIG. 12 is a schematic diagram illustrating one example of a programmable logic integrated circuit mounted with a circuit after arrangement wiring based on the design assistance system according to the first example embodiment of the present invention.

FIG. 13 illustrates one example of a directed graph generated based on reliability control processing of the design assistance system according to the first example embodiment of the present invention.

FIG. 14 is a schematic diagram illustrating one example of a programmable logic integrated circuit mounted with a circuit after a reliability control process in a first reliability mode based on the design assistance system according to the first example embodiment of the present invention.

FIG. 15 is a flowchart for illustrating an operation of a design assistance system according to a second example embodiment of the present invention.

FIG. 16 is a flowchart for illustrating arrangement wiring processing based on the design assistance system according to the second example embodiment of the present invention.

FIG. 17 is a block diagram illustrating one configuration example of a design assistance tool group included in a design assistance system according to a third example embodiment of the present invention.

FIG. 18 illustrates a schematic diagram illustrating a sixth example of a switch resource included in a programmable logic integrated circuit to be designed by the design assistance system according to the third example embodiment of the present invention.

FIG. 19 illustrates a schematic diagram illustrating a seventh example of a switch resource included in a programmable logic integrated circuit to be designed by the design assistance system according to the third example embodiment of the present invention.

FIG. 20 is a flowchart for illustrating an operation of the design assistance system according to the third example embodiment of the present invention.

FIG. 21 is a flowchart for illustrating reliability control processing based on the design assistance system according to the third example embodiment of the present invention.

FIG. 22 is a flowchart for illustrating an operation of a design assistance system according to a fourth example embodiment of the present invention.

FIG. 23 is a conceptual diagram illustrating one example of an operation state of a crossbar switch based on a configuration of PTL 1.

FIG. 24 is a conceptual diagram illustrating one example of an operation state of a crossbar switch based on a configuration of PTL 2.

FIG. 25 is a conceptual diagram illustrating one example in which an open defect occurs in a resistance change element included in the crossbar switch based on the configuration of PTL 1.

FIG. 26 is a conceptual diagram illustrating one example in which a short-circuit defect occurs in a resistance change element included in a crossbar switch based on the configuration of PTL 1.

FIG. 27 is a conceptual diagram illustrating one example in which an open defect occurs in a resistance change element included in a crossbar switch based on the configuration of PTL 2.

FIG. 28 is a conceptual diagram illustrating one example in which a short-circuit defect occurs in a resistance change element included in a crossbar switch based on the configuration of PTL 2.

### EXAMPLE EMBODIMENT

Hereinafter, example embodiments of the present invention are described with reference to the accompanying drawings. However, the example embodiments described below are limited technically preferably in order to carry out the present invention, but do not limit the scope of the invention to the following. In all figures used for describing the following example embodiments, a similar portion is assigned with the same reference sign unless there is a special reason. According to the following example embodiments, a repetitive description may be omitted for a similar configuration/operation. A direction of an arrow in a figure indicates one example and does not limit a direction of signals between blocks.

### First Example Embodiment

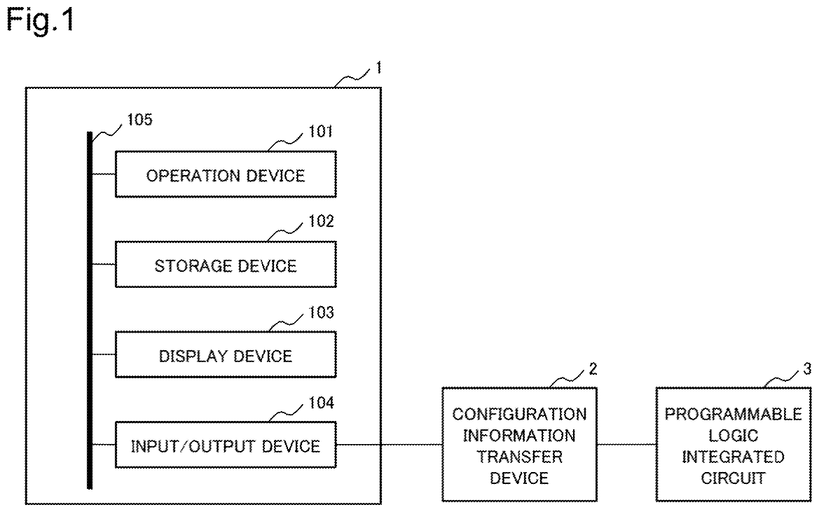

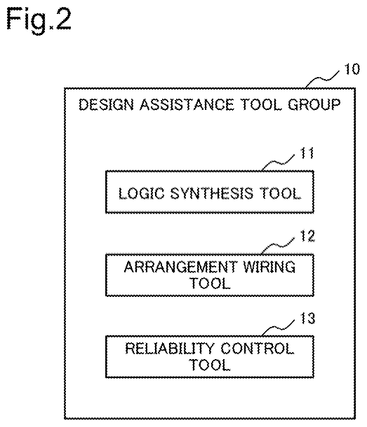

First, a design assistance system according to a first example embodiment of the present invention is described with reference to drawings. FIG. 1 is a conceptual diagram for illustrating a configuration of a design assistance system 1 according to the present example embodiment. FIG. 2 is a block diagram illustrating a configuration of a design assistance tool group 10 included in the design assistance system 1 according to the present example embodiment.

As described in FIG. 1, the design assistance system 1 is connected to a configuration information transfer device 2. The design assistance system 1 is connected to a programmable logic integrated circuit 3 via the configuration information transfer device 2. A connection between the design assistance system 1 and the configuration information transfer device 2 and a connection between the configuration information transfer device 2 and the programmable logic integrated circuit 3 may be achieved in either of a wired manner and a wireless manner, and a communication method of signals in these connections is not specifically limited. The configuration information transfer device 2 and the programmable logic integrated circuit 3 may be mounted as an application board on the design assistance system 1.

As in FIG. 1, the design assistance system 1 includes an operation device 101, a storage device 102, a display device 103, and an input/output device 104. The operation device 101, the storage device 102, the display device 103, and the input/output device 104 are mutually connected via a bus 105. The design assistance system 1 is achieved, for example, by a computer system.

The operation device 101 executes processing in accordance with a program previously stored in the storage device 102 and thereby controls a whole operation of the design assistance system 1. The operation device 101 executes processing in accordance with a program previously stored in the storage device 102 and thereby achieves a function of the design assistance tool group 10.

The storage device 102 is a storage medium such as a memory for storing design information and a program. Design information includes operation description information of a circuit created by a designer and information such as restriction condition information mounted on the programmable logic integrated circuit 3. Design information includes, for example, information such as net list information being a processing result of the operation device 101, arrangement wiring information, resource information and configuration information of the programmable logic integrated circuit 3, rewrite history information.

The display device 103 displays an instruction input screen and a processing result of the design assistance tool group 10. The display device 130 displays, for example, information relating to the number of rewrites (referred also to the number of modifications) of a resistance change element. The display device 103 displays, for example, display information such as graph display of data after statistical processing, color display on a floor planner. For example, a user confirms the display information of the display device 103 and thereby can create a floor plan that avoids a portion having a large number of rewrites.

The input/output device 104 is an interface circuit in which signals and data are transmitted/received among an input device such as a keyboard, a mouse, a touch panel, the configuration information transfer device 2, and an output device such as a printing device (not illustrated). The input/output device 104 provides a setting based on a reliability mode with a user. A user uses a function provided by the input/output device 104 and thereby can mount, on the programmable logic integrated circuit 3, a circuit in which storage characteristics of data of a resistance change element are prioritized or a circuit in which a rewriting life of a resistance change element is prioritized.

The configuration information transfer device 2 is connected to the design assistance system 1 and the programmable logic integrated circuit 3. The configuration information transfer device 2 controls data transmission of configuration information between the design assistance system 1 and the programmable logic integrated circuit 3. The configuration information transfer device 2, for example, receives data such as configuration information transmitted from the design assistance system 1, converts the data to transmission data of a data input/output specification of the programmable logic integrated circuit 3, and transfers the transmission data. The configuration information transfer device 2, for example, receives data such as configuration information output from the programmable logic integrated circuit 3, converts the data to transmission data of a data input/output specification of the design assistance system 1, and transfers the transmission data. A data conversion method based on the configuration information transfer device 2 is not specifically limited.

The design assistance tool group 10 in FIG. 2 is a tool that is previously stored in the storage device 102 in FIG. 1, is read by the operation device 101 from the storage device 102, and is executed. As illustrated in FIG. 2, the design assistance tool group 10 includes a logic synthesis tool 11, an arrangement wiring tool 12, and a reliability control tool 13.

The logic synthesis tool 11 (also referred to as a logic synthesis means) inputs an operation description file including operation description information, and/or restriction condition information such as delay, power, input by a designer of the programmable logic integrated circuit 3 by using the input/output device 104. The logic synthesis tool 11 logically synthesizes an input operation description file. The logic synthesis tool 11 generates a net list by using a logic element included in the programmable logic integrated circuit 3. The net list includes logic elements and connection information among the logic elements.

The arrangement wiring tool 12 (also referred to as an arrangement wiring means) generates a logic element of the programmable logic integrated circuit 3 and resource information such as a wiring resource. The arrangement wiring tool 12 virtually arranges/wires, based on the resource information of the programmable logic integrated circuit 3, logic elements included in a net list. In other words, the arrangement wiring tool 12 arranges, based on the generated resource information, logic elements included in a net list, and generates at least one signal path by wiring the arranged logic elements.

The reliability control tool 13 (also referred to as a reliability control means) generates, based on a reliability mode, configuration information of a circuit in which storage characteristics of data or a rewriting life with respect to a resistance change element is prioritized. A reliability mode includes a first reliability mode for adding a signal path and a second reliability mode for not adding a signal path. In other words, the reliability control tool 13 generates, based on at least two reliability modes, configuration information of a programmable logic integrated circuit, and outputs the generated configuration information. The reliability control tool 13, for example, causes configuration information to be displayed on the display device 103 and causes configuration information to be output from the input/output device 104 to the configuration information transfer device 2.

The reliability control tool 13 allocates, in a first reliability mode, a wiring resource and a switch resource to a second signal path parallel to a first signal path wired by the arrangement wiring tool 12. The reliability control tool 13 does not add, in a second reliability mode, a signal wiring to a first signal path wired by the arrangement wiring tool 12. The reliability control tool 13 preferably, when possible, allocates, in a first reliability mode, the same wiring resource to a first signal path and a second signal path.

The above is a description of a configuration of the design assistance system 1. Next, an operation of the design assistance system 1 is described with reference to a drawing.

(Operation)

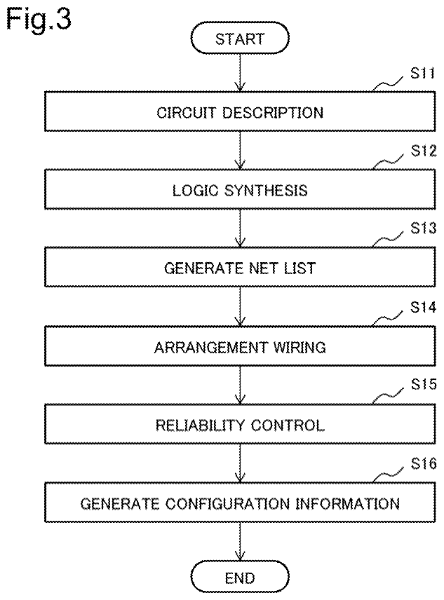

FIG. 3 is a flowchart for illustrating a design assistance method based on the design assistance system according to the present example embodiment. In the following description in accordance with the flowchart in FIG. 3, the design assistance system 1 is described as an operation subject.

In FIG. 3, first, the design assistance system 1 receives an operation description file of a circuit created by a designer (step S11). An operation description file is input by the input/output device 104.

An operation description file is generated, for example, by using a hardware description language. One example of a hardware description language includes a verilog-hardware description language (HDL). In addition, one example of a hardware description language includes a very high-speed integrated circuit hardware description language (VHDL).

Next, the design assistance system 1 logically synthesizes the input operation description file (step S12). Logic synthesis of an operation description file is executed by the logic synthesis tool 11.

Next, the design assistance system 1 generates a net list (step S13). A net list is generated by the logic synthesis tool 11. The logic synthesis tool 11 generates a net list by using a logic element included in the programmable logic integrated circuit 3. The logic synthesis tool 11 optimizes a circuit in such a way as to satisfy timing restriction information previously set by a designer.

Next, the design assistance system 1 executes arrangement wiring processing of a circuit to be mounted on the programmable logic integrated circuit 3 (step 14). Arrangement wiring processing of a circuit is executed by the arrangement wiring tool 12.

Next, the design assistance system 1 modifies an arrangement wiring result, based on a reliability mode and generates configuration information (step S15). Generation of configuration information is executed by a reliability control tool.

When configuration information of a circuit is determined, the configuration information transfer device 2 is connected to the design assistance system 1 and the programmable logic integrated circuit 3, based on an operation executed by a designer for the input/output device 104. As a result, a communication path between the design assistance system 1 and the programmable logic integrated circuit 3 is established. The design assistance system 1 transmits configuration information to the programmable logic integrated circuit 3 via the configuration information transfer device 2. The programmable logic integrated circuit 3 starts, when receiving configuration information from the configuration information transfer device 2, a configuration operation. When configuration operations for all pieces of configuration information are completed, a state where a circuit is mounted on the programmable logic integrated circuit 3 is established.

The above is a description of an operation of the design assistance system 1. Next, with reference to a drawing, details of an operation of the design assistance system 1 are described.

[Arrangement Wiring Processing]

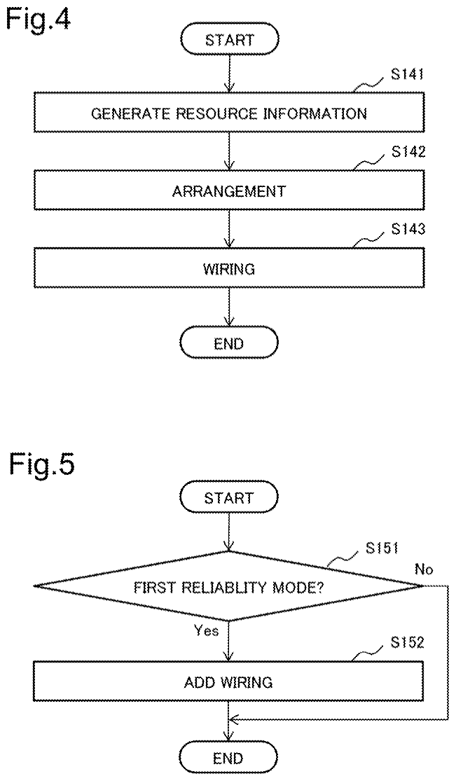

FIG. 4 is a flowchart for illustrating details of arrangement wiring processing (step S14) executed by the arrangement wiring tool 12 of the design assistance system 1. In the following description in accordance with the flowchart in FIG. 4, the arrangement wiring tool 12 is described as an operation subject.

In FIG. 4, first, the arrangement wiring tool 12 generates resource information such as a logic element and a routing resource (step S141).

In order to store configuration information of a logic element, a memory resource constituted of a resistance change element is usable. A routing resource is constituted of a wiring resource and a switch resource. A switch resource may be constituted of a resistance change element. Resource information may include information in which a discrimination number of a certain logic element and a discrimination number of a resistance change element inside a switch resource storing configuration information of the logic element are combined as one set. Resource information may include a directed graph or a non-directed graph of a wiring resource as information in which a discrimination number of a certain wiring resource and a discrimination number of a resistance change element inside a switch resource connected to the wiring resource are linked.

Next, the arrangement wiring tool 12 allocates each logic element included in a net list to an arrangement slot of the programmable logic integrated circuit 3 (step S142).

A slot is a place where a logic element is arranged. The arrangement wiring tool 12 searches for, for example, by using a total sum of virtual wiring lengths of a net as an evaluation value (also referred to as an evaluation function), an arrangement that minimizes the evaluation function. A virtual wiring length of a net is, for example, a sum of a length of an x-axis direction and a length of a y-axis direction of a rectangle surrounding slot positions of all logic elements included in the net. An evaluation function used by the arrangement wiring tool 12 is not limited to the evaluation function cited here.

Next, the arrangement wiring tool 12 determines which wiring resource and switch resource each logic element included in a net list uses for connecting (step S143).

The arrangement wiring tool 12 searches for, in order to achieve minimization of a delay time and avoidance of being unable to find a wiring path, a wiring that minimizes an evaluation function including a delay cost and a congestion cost. A delay cost is a cost calculated based on a delay time of a wiring path. A congestion cost is a cost calculated based on the number of nets competing with respect to a certain routing resource. The arrangement wiring tool 12 eliminates competition by executing repetitive wiring while gradually increasing a congestion cost.

The arrangement wiring tool 12 may execute, when it is unable to eliminate competition, wiring by using another procedure such as logic duplication.

The above is a description of arrangement wiring processing based on the arrangement wiring tool 12.

[Reliability Control Processing]

FIG. 5 is a flowchart for illustrating details of reliability control processing (step S15) executed by the reliability control tool 13 of the design assistance system 1. In the following description in accordance with the flowchart in FIG. 5, the reliability control tool 13 is described as an operation subject.

The reliability control tool 13 adds, when a first reliability mode is set as a reliability mode (Yes in step S151), a signal path (step S152). In this case, the reliability control tool 13 allocates, based on connection information of a circuit, a wiring resource and a switch resource to a signal path parallel to an existing signal path of each net. However, the reliability control tool 13 searches for a parallel signal path to the extent that does not affect a wiring path of another net.

In contrast, the reliability control tool 13 does not add, when a second reliability mode is set as a reliability mode (No in step S151), a signal path.

The above is a description of reliability control processing based on the reliability control tool 13. Next, processing of adding a parallel signal path is described with reference to a drawing.

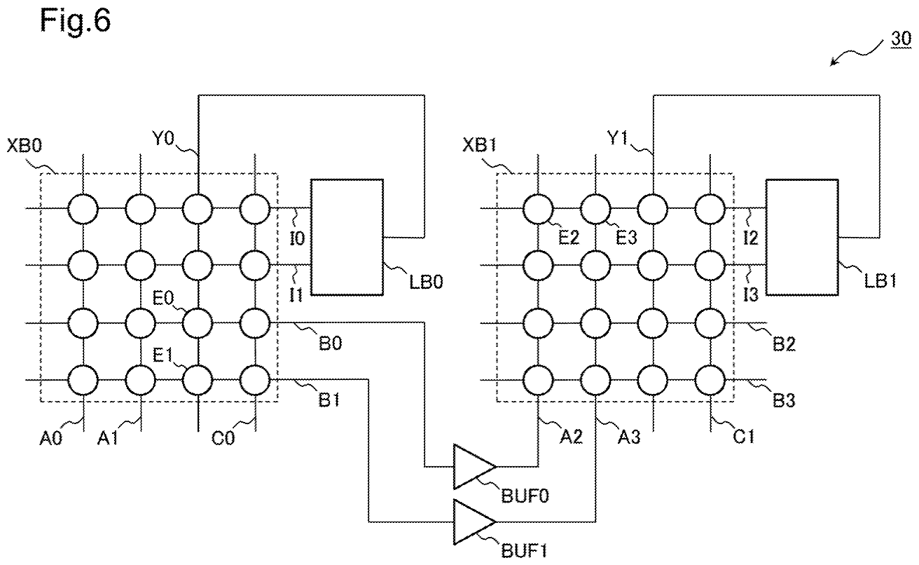

FIG. 6 is a schematic diagram illustrating one example of two logic blocks included in the programmable logic integrated circuit 3 and a routing resource connecting these logic blocks. In FIG. 6, the logic blocks (LB0, LB1) as a logic element include two input terminals and one output terminal. In FIG. 6, the routing resource is constituted of two crossbar switches (XB0, XB1) and two buffer circuits (BUF0, BUF1).

The crossbar switch (XB0, XB1) includes a wiring resource and a switch resource. In FIG. 6, the wiring resource is constituted of four column wirings extending in a column direction and four row wirings extending in a row direction. In FIG. 6, the switch resource is constituted of a plurality of resistance change elements (16 elements in FIG. 6) each located in an intersection between a column wiring and a row wiring. By transiting a state of a resistance change element included in a crossbar switch, any wiring in column wirings and any wiring in row wirings can be connected or disconnected.

The crossbar switch XB0 includes a column wiring A0 and a column wiring A1 as an input line. A column wiring Y0 being one wiring resource of the crossbar switch XB0 is connected to an output terminal of the logic block LB0. A column wiring C0 being one wiring resource of the crossbar switch XB0 is grounded. The crossbar switch XB0 includes a row wiring I0 and a row wiring I1 as an output line. The row wiring I0 and the row wiring I1 are connected to an input terminal of the logic block LB0. The crossbar switch XB0 includes a row wiring B0 and a row wiring B1 as an output wiring. The row wiring B0 is connected to an input terminal of the buffer circuit BUF0. The row wiring B1 is connected to an input terminal of the buffer circuit BUF1.

The crossbar switch XB1 includes a column wiring A2 and a column wiring A3 as an input line. The column wiring A2 is connected to an output terminal of the buffer circuit BUF0. The column wiring A3 is connected to an output terminal of the buffer circuit BUF1. A column wiring Y1 being one wiring resource of the crossbar switch XB1 is connected to an output terminal of the logic block LB1. A column wiring C1 being one wiring resource of the crossbar switch XB1 is grounded. The crossbar switch XB1 includes a row wiring 12 and a row wiring 13 as an output line. The row wiring 12 and the row wiring 13 are connected to an input terminal of the logic block LB1. The crossbar switch XB1 includes a row wiring B2 and a row wiring B3 as an output wiring.

[Switch Resource]

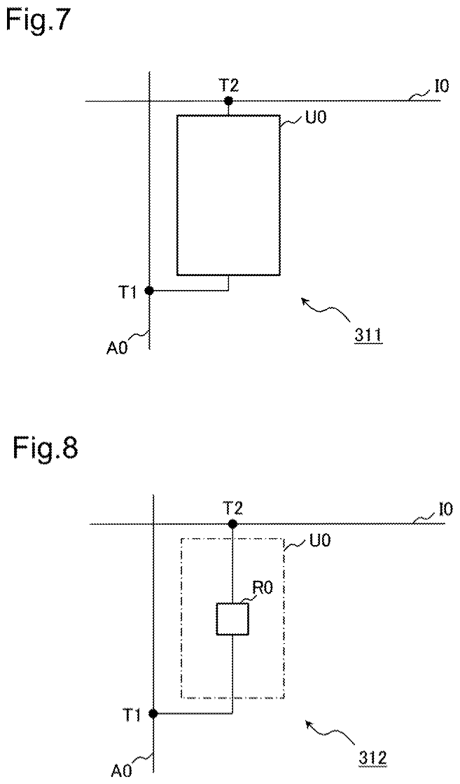

FIG. 7 to FIG. 11 each are a schematic diagram illustrating one example (a first to a fifth example) of a switch resource included in the programmable logic integrated circuit 3. In a description of FIG. 7 to FIG. 11, for a component exhibiting a similar function, the same reference sign may be used.

A switch resource 311 according to a first example illustrated in FIG. 7 includes a unit cell U0. The unit cell U0 includes a first terminal T1 and a second terminal T2. The first terminal T1 is connected to a column wiring A0. The second terminal T2 is connected to a row wiring I0. The switch resource 311 is conductive when the unit cell U0 is in an ON-state and is cut off when the unit cell U0 is in an OFF-state. When the unit cell U0 is in an ON-state, signals are propagated between the column wiring A0 and the row wiring T0.

A switch resource 312 according to a second example illustrated in FIG. 8 includes a unit cell U0 constituted of a resistance change element R0, a first terminal T1, and a second terminal T2. The first terminal T1 is connected to a column wiring A0, and the second terminal T2 is connected to a row wiring T0. The unit cell U0 is defined as being in an ON-state when the resistance change element R0 is in a low resistance state and is defined as being in an OFF-state when the resistance change element R0 is in a high resistance state. When the unit cell U0 is in an ON-state, signals are propagated between the column wiring A0 and the row wiring T0.

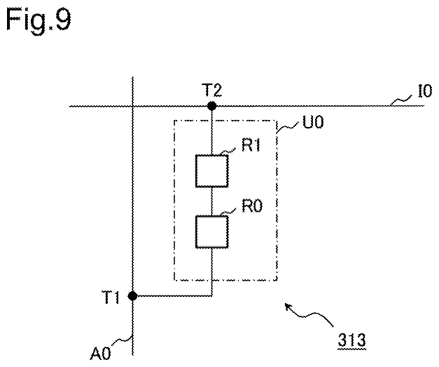

A switch resource 313 according to a third example illustrated in FIG. 9 includes a unit cell U0 constituted of a resistance change element R0, a resistance change element R1, a first terminal T1, and a second terminal T2. The resistance change element R0 and the resistance change element R1 included in the unit cell U0 are connected to each other in series. The first terminal T1 is connected to a column wiring A0, and the second terminal T2 is connected to a row wiring I0. The unit cell U0 is defined as being in an ON-state when the resistance change element R0 and the resistance change element R1 are in a low resistance state and is defined as being in an OFF-state when the resistance change elements R0 and R1 are in a high resistance state. When the unit cell U0 is in an ON-state, signals are propagated between the column wiring A0 and the row wiring I0.

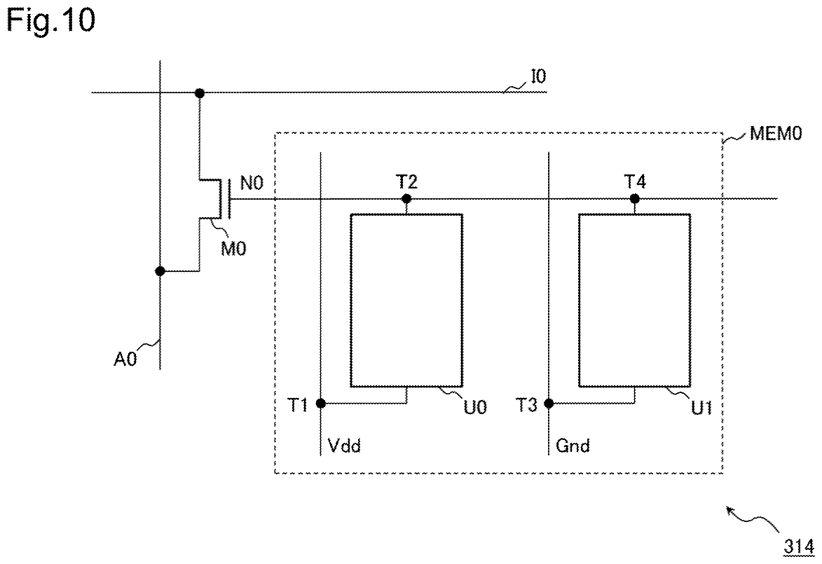

A switch resource 314 according to a fourth example illustrated in FIG. 10 is constituted of a transistor M0 and a memory MEMO. Either a source or a drain of the transistor M0 is connected to a column wiring A0, and the other is connected to a row wiring I0. A gate of the transistor M0 is connected to an output N0 of the memory MEMO.

The memory MEMO in FIG. 10 includes a unit cell U0 and a unit cell U1. A first terminal T1 of the unit cell U0 is connected to a power source Vdd. A second terminal T2 of the unit cell U0 is connected to the output N0. A third terminal T3 of the unit cell U1 is connected to a ground Gnd. A fourth terminal T4 of the unit cell U1 is connected to the output N0. The unit cell U0 and the unit cell U1 in FIG. 10 include a resistance change element illustrated in FIG. 8 and FIG. 9.

The switch resource 314 in FIG. 10 causes, when the unit cell U0 is in a ON-state and the unit cell U1 is in an OFF-state, the output N0 to be at a high level (Vdd voltage level) and signals to pass. In contrast, the switch resource 314 in FIG. 10 causes, when the unit cell U0 is in an OFF-state and the unit cell U1 is in an ON-state, the output N0 to be at a low level (Gnd voltage level) and signals to be cut off.

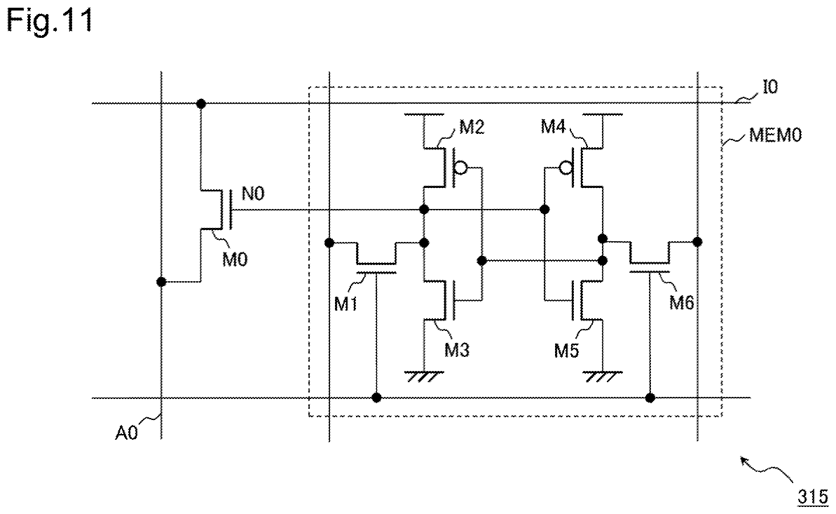

A switch resource 315 according to a fifth example illustrated in FIG. 11 is constituted of a transistor M0 and a memory MEMO. Either a source or a drain of the transistor M0 is connected to a column wiring A0, and the other is connected to a row wiring I0. A gate of the transistor M0 is connected to an output N0 of the memory MEMO. The memory MEMO in FIG. 11 is constituted of a static random access memory (SRAM) including six transistors M1 to M6. The switch resource 315 in FIG. 11 causes, when the output N0 is at a high level (Vdd voltage level), signals to pass and causes, when the output N0 is in a low level (Gnd voltage level), signals to be cut off.

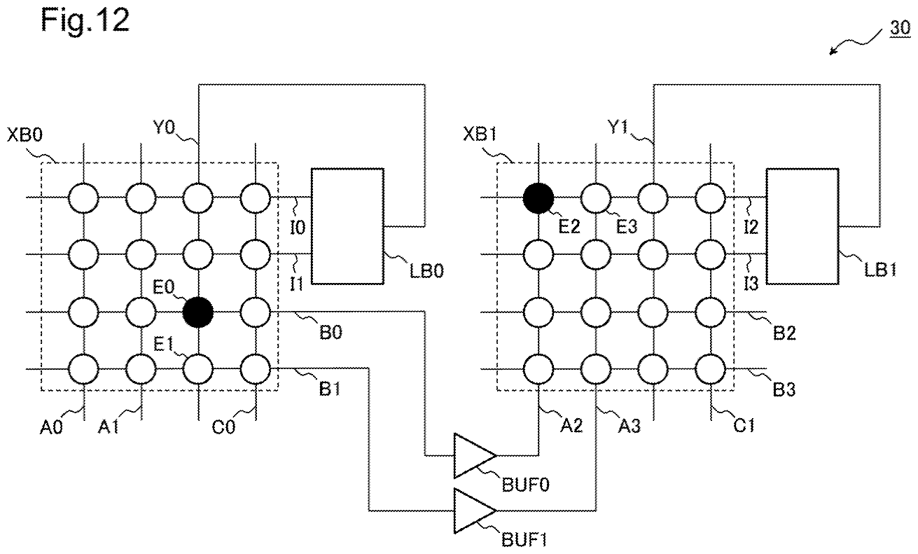

FIG. 12 illustrates one example of a state where the arrangement wiring tool 12 wires an existing signal path in response to a connection request from an output terminal of a logic block LB0 to an input terminal of an LB1. FIG. 12 illustrates a state where an existing signal path is wired in order of a column wiring Y0, a switch resource E0, a row wiring B0, a buffer circuit BUF0, a column wiring A2, a switch resource E2, and a row wiring 12. The reliability control tool 13 searches for, when executing processing of adding a signal path parallel to an existing signal path, a parallel signal path, based on a graph relating to a wiring resource. Herein, a switch resource E0, a switch resource E1, a switch resource E2, and a switch resource E3 each are related resistance change elements.

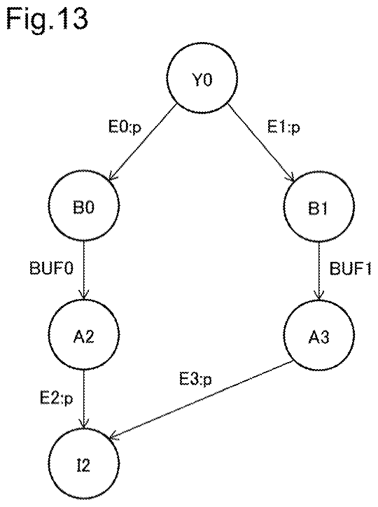

FIG. 13 illustrates a directed graph indicating an existing signal path and a parallel signal path responding to a connection request. In FIG. 13, a node indicated by a circle indicates a wiring, and an edge indicated by a solid line with an arrowhead (an arrow) indicates either a switch resource or a buffer circuit. In FIG. 13, a failure probability p of ON-state maintenance in which an ON-state is changed to an OFF-state after a certain time has elapsed is added to a switch resource.

FIG. 13 illustrates an existing signal path wired by the arrangement wiring tool 12. The existing signal path is a signal path constituted of a column wiring Y0, a switch resource E0, a row wiring B0, a buffer circuit BUF0, a column wiring A2, a switch resource E2, and a row wiring 12. In addition, FIG. 13 illustrates one parallel signal path searched by the reliability control tool 13. The parallel path is a signal path constituted of a column wiring Y0, a switch resource E1, a row wiring B1, a buffer circuit BUF1, a column wiring A3, a switch resource E3, and a row wiring 12. A directed graph including an existing signal path and a parallel path is displayed, for example, on the display device 103.

An existing signal path causes, due to a maintenance failure of an ON-state of a switch resource, a signal propagation error at a probability P1 represented by the following expression 1 after a certain time has elapsed.

P1=2p(1−p)+p²≃2p (1)

In contrast, a signal path parallel to an existing signal path causes, due to a maintenance failure of an ON-state of a switch resource, a signal propagation error at a probability P2 represented by the following expression 2 after a certain time has elapsed.

P2=[2p(1−p)+p²]²≃4p² (2)

A failure probability p of ON-state maintenance is sufficiently smaller than 1, and therefore by adding a signal path parallel to the existing signal path to the existing signal path, an occurrence probability of a signal propagation error can be reduced.

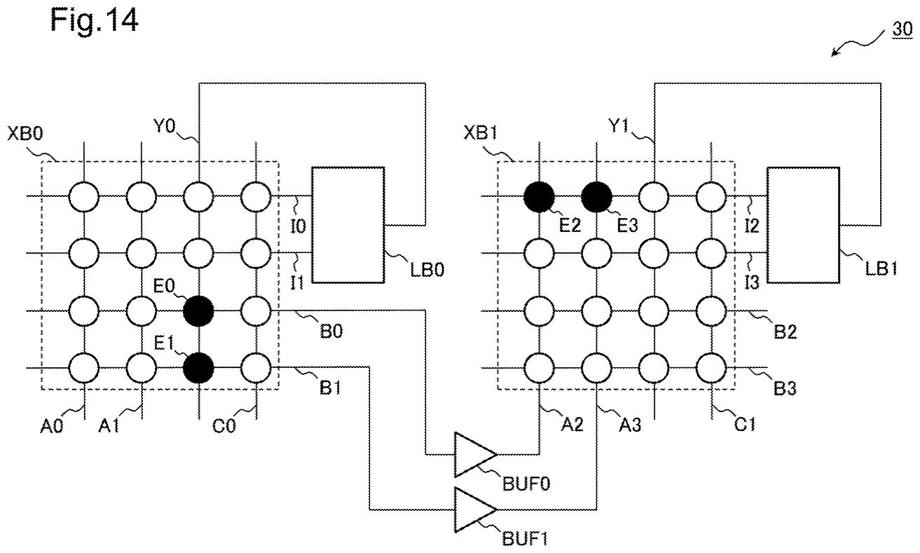

FIG. 14 is a schematic diagram after the reliability control tool 13 adds a parallel signal path when a first reliability mode is set as a reliability mode. The reliability control tool 13 allocates the same wiring resource to a signal path parallel to an existing signal path. Similarly, the reliability control tool 13 allocates the same wiring resource to a signal path parallel to an existing signal path. While it is necessary to parallelize switch resources since reliability of a switch resource is lower than reliability of a wiring resource, it is unnecessary to parallelize wiring resources. From a point of view of resource consumption and power consumption, it is desirable that a wiring resource is shared between an existing signal path and a parallel signal path as much as possible.

When a second reliability mode is set as a reliability mode, the reliability control tool 13 does not add a signal path. In other words, a state where a second reliability mode is set is equivalent to FIG. 12. A second reliability mode can reduce the number of switch resources to be used, compared with a case (FIG. 14) where a first reliability mode is set. Therefore, according to a second reliability mode, a frequency of occurrence of rewrites of a resistance change element configuring a switch resource can be reduced. A second reliability mode is useful, for example, for a debugging period of a mounted circuit having high rewrite frequency.

As described above, according to the design assistance system of the present example embodiment, when a first reliability mode is set, a signal propagation error due to a maintenance failure of an ON-state of a switch resource constituted of a resistance change element is reduced, and thereby reliability of a circuit to be mounted can be improved. According to the design assistance system of the present example embodiment, when a second reliability mode is set, the number of rewrites of a resistance change element included in a programmable logic integrated circuit can be reduced, compared with a first reliability mode.

In other words, according to the present example embodiment, a highly reliable programmable logic integrated circuit can be provided.

### Second Example Embodiment

Next, a design assistance system according to a second example embodiment of the present invention is described with reference to drawings. The design assistance system according to the present example embodiment is different from the first example embodiment in a point that arrangement wiring processing based on a reliability mode is executed. A configuration of the design assistance system according to the present example embodiment is similar to the configuration of the first example embodiment, and therefore a description thereof is omitted. In the following description, with reference to FIG. 1 and FIG. 2, a description is made by using a reference sign assigned to each of components according to the first example embodiment.

(Operation)

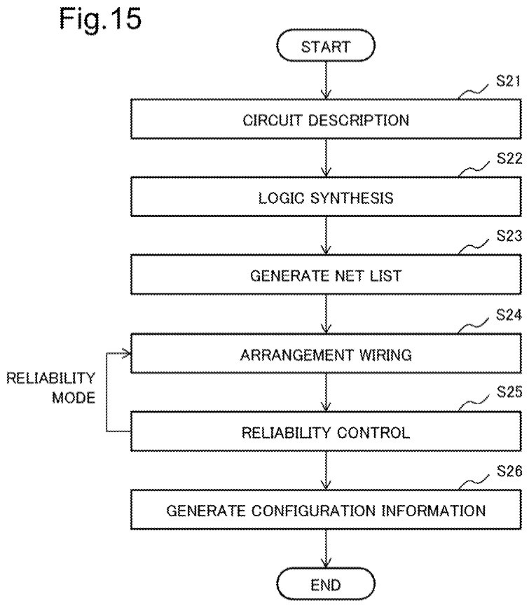

First, an operation of the design assistance system according to the present example embodiment is described with reference to a drawing. FIG. 15 is a flowchart for illustrating a design assistance method based on the design assistance system according to the present example embodiment.

Processing of steps S21 to S26 of the flowchart in FIG. 15 is related to processing of steps S11 to S16 of the flowchart in FIG. 3. The present example embodiment is different from the first example embodiment in arrangement wiring processing of step S24, and other processing steps are similar to the processing steps of the first example embodiment.

In FIG. 15, the setting of a reliability mode from a reliability control tool 13 is indicated by an arrow. A timing of setting a reliability mode from the reliability control tool 13 to an arrangement wiring tool 12 is optionally set. In the following, arrangement wiring processing (step S24 in FIG. 15) is described in detail.

[Arrangement Wiring Processing]

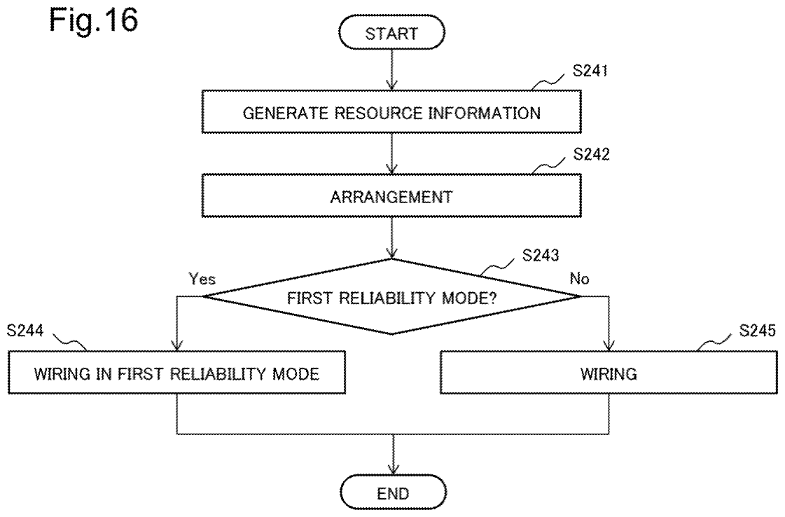

FIG. 16 is a flowchart for illustrating wiring arrangement processing (step S24 of FIG. 15) based on the arrangement wiring tool 12. In the following description in accordance with the flowchart in FIG. 16, the arrangement wiring tool 12 is described as an operation subject.

In FIG. 16, first, the arrangement wiring tool 12 generates resource information such as a logic element and a routing resource (step S241).

Next, the arrangement wiring tool 12 allocates each logic element included in a net list to an arrangement slot of a programmable logic integrated circuit 3 (step S242).

The arrangement wiring tool 12 executes wiring processing based on the setting of a reliability mode from the reliability control tool 13.

The arrangement wiring tool 12 executes, when a first reliability mode is set (Yes in step S243), wiring processing of a first reliability mode (step S244). In wiring processing of a first reliability mode, the arrangement wiring tool 12 configures a connection of logic elements included in a net list, based on a first signal path and a second signal path. The arrangement wiring tool 12 determines, in wiring processing of a first reliability mode, which wiring resource and switch resource a first signal path and a second signal path use for connecting.

The arrangement wiring tool 12 searches for, for example, a wiring that minimizes an evaluation value (also referred to as an evaluation function) including a delay cost and a congestion cost. The arrangement wiring tool 12 calculates a delay cost, based on a delay time of a wiring path. The arrangement wiring tool 12 calculates a congestion cost, based on the number of nets competing with respect to a certain wiring resource. The arrangement wiring tool 12 eliminates competition by executing repetitive wiring while gradually increasing a congestion cost. The arrangement wiring tool 12 executes, when it is unable to eliminate competition, wiring by using another procedure such as logic duplication.

In contrast, the arrangement wiring tool 12 executes, when a second reliability mode is set (No in step S243), wiring processing of a second reliability mode. The arrangement wiring tool 12 determines, in wiring processing of a second reliability mode, which wiring resource and switch resource each logic element included in a net list uses for connecting (step S245).

The above is a description of processing of the design assistance system according to the present example embodiment.

As described above, the design assistance system according to the present example embodiment collectively executes wiring by using an evaluation function including a delay cost and a congestion cost. Therefore, according to the present example embodiment, options for a wiring path increase, compared with the first example embodiment, and therefore a more optimum wiring path can be selected.

### Third Example Embodiment

Next, a design assistance system according to a third example embodiment of the present invention is described with reference to drawings. The design assistance system according to the present example embodiment is different from the first example embodiment in a point that rewrite history information of a resistance change element is generated. A configuration of the design assistance system according to the present example embodiment is similar to the configuration of the first example embodiment, and therefore a description thereof is omitted. In the following description, with reference to FIG. 1, a description is made by using a reference sign assigned to each of components of the first example embodiment.

[Design Assistance Tool Group]

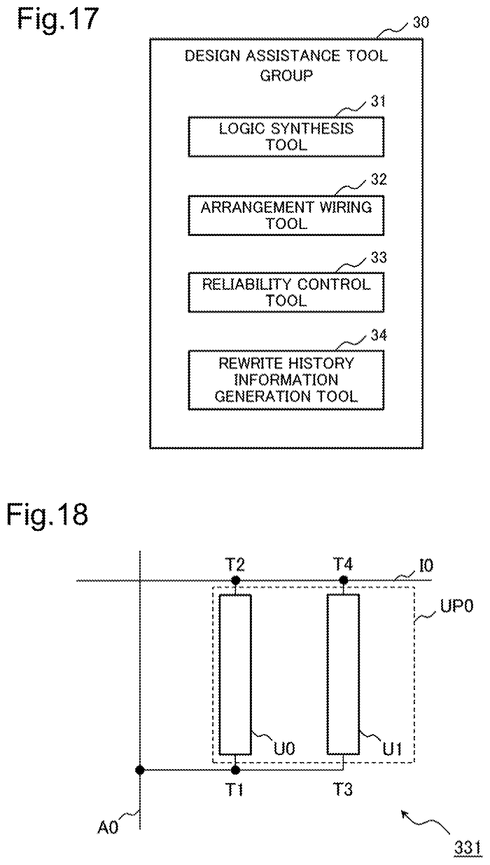

FIG. 17 is a block diagram illustrating a configuration of a design assistance tool group 30 included in the design assistance system according to the present example embodiment. The design assistance tool group 30 in FIG. 17 is a tool that is previously stored in the storage device 102 in FIG. 1, is read by the operation device 101 from the storage device, and is executed. As in FIG. 17, the design assistance tool group 30 according to the present example embodiment includes a logic synthesis tool 31, an arrangement wiring tool 32, a reliability control tool 33, and a rewrite history information generation tool 34. The logic synthesis tool 31, the arrangement wiring tool 32, and the reliability control tool 33 are similar to related components according to the first example embodiment, and therefore a description thereof is omitted.

The rewrite history information generation tool 34 (also referred to as a rewrite history information generation means) generates, based on configuration information read from a programmable logic integrated circuit 3, rewrite history information unique to a device. Rewrite history information includes address information indicating a state of a resistance change element included in a logic element or a connection element that are included in the programmable logic integrated circuit 3, and rewrite number information indicating the number of modifications (rewrites).

[Switch Resource]

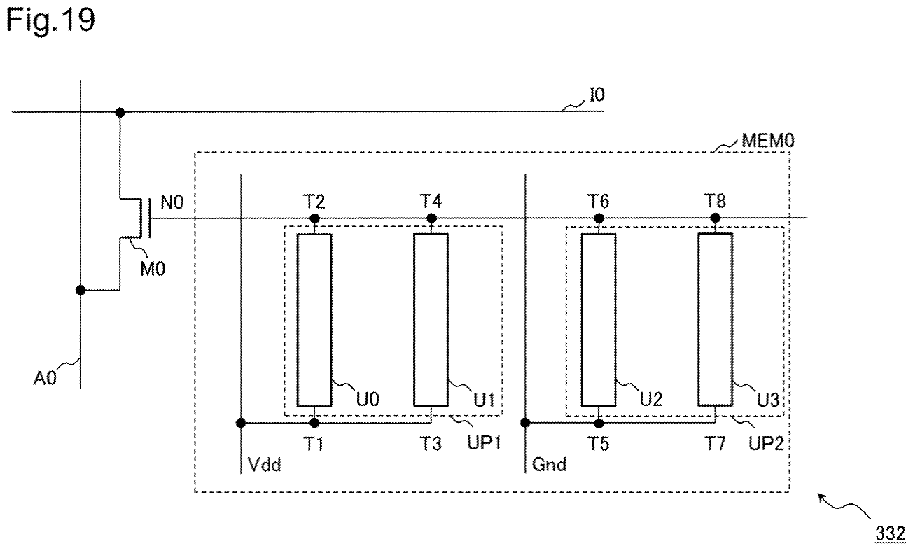

FIG. 18 and FIG. 19 each are a schematic diagram illustrating one example (a sixth and a seventh example) of a switch resource included in the programmable logic integrated circuit 3. According to the present example embodiment, two unit cells inside a switch resource are previously prepared and these unit cells are connected in parallel. A unit cell illustrated in FIG. 18 and FIG. 19 is a unit cell constituted of the resistance change element illustrated in FIG. 8 and FIG. 9. In a description of FIG. 18 and FIG. 19, for a component exhibiting a similar function, the same reference sing may be used.

A switch resource 331 of the sixth example illustrated in FIG. 18 is constituted of a unit-cell pair UP0 including a unit cell U0 and a unit cell U1. The unit cell U0 includes a first terminal T1 and a second terminal T2. The unit cell U1 includes a third terminal T3 and a fourth terminal T4. The first terminal T1 and the third terminal T3 are connected to a column wiring A0. The second terminal T2 and the fourth terminal T4 are connected to a row wiring T0.

For the unit-cell pair UP0, three states including a first ON-state, a second ON-state, and an OFF-state are defined. The first ON-state is a state where both the unit cell U0 and the unit cell U1 are in an ON-state. The second ON-state is a state where either of the unit cell U0 or the unit cell U1 is in an ON-state and the other is in an OFF-state. The OFF-state is a state where both the unit cell U0 and the unit cell U1 are in an OFF-state. The switch resource 331 causes signals to pass when the unit-cell pair UP0 is in a first ON-state or a second ON-state. In contrast, the switch resource 331 cuts off signals when the unit-cell pair UP0 is in an OFF-state.

A switch resource 332 according to the second example illustrated in FIG. 19 is constituted of a transistor M0 and a memory MEMO. Either one of a source and a drain of the transistor M0 is connected to a column wiring A0 and the other is connected to a row wiring I0. A gate of the transistor M0 is connected to an output N0 of the memory.

The memory MEMO in FIG. 19 includes four unit cells U0, U1, U2, and U3. The memory MEMO in FIG. 19 includes a unit-cell pair UP1 constituted of a unit cell U0 and a unit cell U1 and a unit-cell pair UP2 constituted of a unit cell U2 and a unit cell U3. For the unit-cell pair UP1 and the unit-cell pair UP2, similarly to the unit-cell pair UP0 included in the switch resource 331 in FIG. 18, three states of a first ON-state, a second ON-state, and an OFF-state are defined.

The unit cell U0 includes a first terminal T1 and a second terminal T2. The unit cell U1 includes a third terminal T3 and a fourth terminal T4. The first terminal T1 and the third terminal T3 are connected to a power supply Vdd. The second terminal T2 and the fourth terminal T4 are connected to an output N0. The unit cell U2 includes a fifth terminal T5 and a sixth terminal T6. The unit cell U3 includes a seventh terminal T7 and an eighth terminal T8. The fifth terminal T5 and the seventh terminal T7 are connected to a ground Gnd. The sixth terminal T6 and the eighth terminal T8 are connected to the output N0.

The switch resource 332 causes, when the unit-cell pair UP1 is in a first ON-state and the unit-cell pair UP2 is in an OFF-state, the output N0 to be at a high level (Vdd voltage level) and passes signals. The switch resource 332 causes, when the unit-cell pair UP1 is in a second ON-state and the unit-cell pair UP2 is in an OFF-state, the output N0 to be at a high level (Vdd voltage level) and passes signals.

In contrast, the switch resource 332 causes, when the unit-cell pair UP1 is in an OFF-state and the unit-cell pair UP2 is in a first ON-state, the output N0 to be in at a low level (Gnd voltage level) and cuts off signals. The switch resource 332 causes, when the unit-cell pair UP1 is in an OFF-state and the unit-cell pair UP2 is in a second ON-state, the output N0 to be in at a low level (Gnd voltage level) and cuts off signals.

The above is a description of a configuration of a switch resource included in the programmable logic integrated circuit 3. Next, an operation of the design assistance system according to the present example embodiment is described with reference to a drawing.

(Operation)

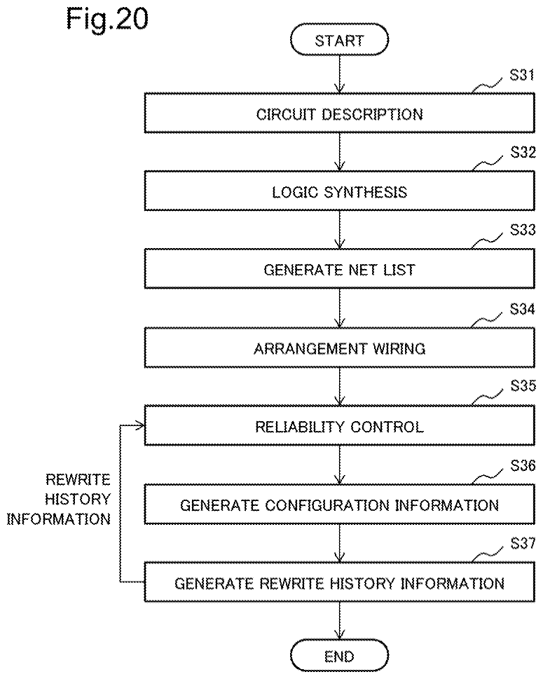

FIG. 20 is a flowchart for illustrating a design assistance method based on the design assistance system according to the present example embodiment. Herein, an example in which a programmable logic integrated circuit 3 already mounted with a circuit A is to be mounted with a circuit B, that is different from the circuit A, is described.

Processing of steps S31 to S36 of the flowchart in FIG. 20 is related to processing of steps S11 to S16 of the flowchart in FIG. 3. The present example embodiment is different from the first example embodiment in a point that rewrite history information generation processing (step S37) is executed, and other processing steps are similar to the processing steps according to the first example embodiment. In the following, rewrite history information generation processing (step S37) is described.

The rewrite history information generation tool 34 generates rewrite history information including address information of resistance change elements included in the programmable logic integrated circuit 3 and information indicating the number of rewrites of a state of each of the resistance change elements (step S37).

The rewrite history information generation tool 34 compares the configuration information read from the programmable logic integrated circuit 3 to a configured programmable logic integrated circuit 3 after configuration (a circuit B) with the configuration information of a circuit A already mounted. The rewrite history information generation tool 34 acquires a difference between the configuration information of the circuit B and the configuration information of the circuit A and thereby updates rewrite history information. The rewrite history information generation tool 34 reads configuration information of the circuit A before configuring configuration information of the circuit B and thereby previously acquires the configuration information of the circuit A. The rewrite history information generation tool 34 supplies the updated rewrite history information to the reliability control tool 33. The rewrite history information supplied to the reliability control tool 33 is used by the reliability control tool 33 when next arrangement wiring is executed. An arrow from step S37 to step S35 in FIG. 20 indicates that rewrite history information generated in Step S37 is reflected in reliability control processing in step S34.

[Reliability Control Processing]

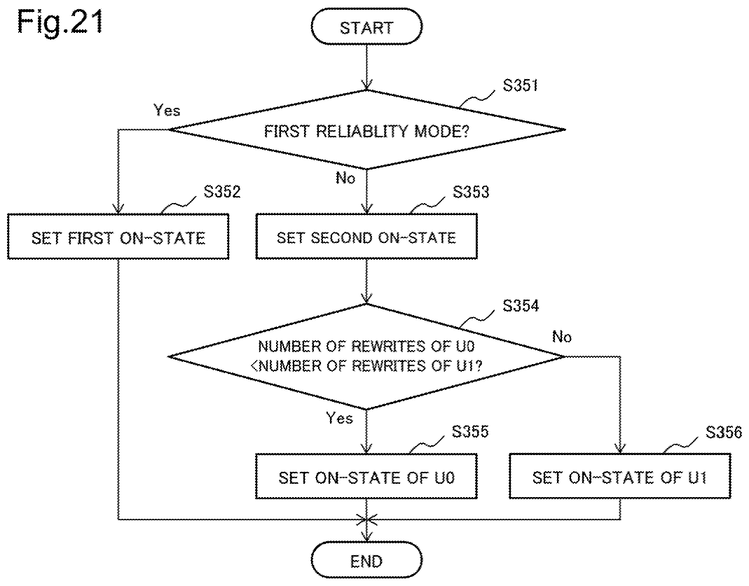

FIG. 21 is a flowchart for illustrating reliability control processing (step S35 in FIG. 20) executed by the reliability control tool 33. In the following, an example in which the switch resource 331 illustrated in FIG. 18 is used is described. The reliability control tool 33 controls, as a result of arrangement wiring based on the arrangement wiring tool 32, which resistance change element is caused to be in an ON-state with respect to a switch resource 331 allocated to a signal path.

In FIG. 21, first, the reliability control tool 33 sets, when as a reliability mode, a first reliability mode is set (Yes in step S351), a unit-cell pair UP0 included in the switch resource 331 to be in a first ON-state (step S352).

In contrast, the reliability control tool 33 sets, when as a reliability mode, a second reliability mode is set (No in step S351), the unit-cell pair UP0 included in the switch resource 331 to be in a second ON-state (step S353).

The reliability control tool 33 determines, when setting the unit-cell pair UP0 to be in a second ON-state, for which resistance change element a resistance state is rewritten based on rewrite history information. In FIG. 21, the reliability control tool 33 compares the number of rewrites of the unit cell U0 with the number of rewrites of the unit cell U1 and determines a resistance change element a resistance state of which is rewritten (step S354).

The reliability control tool 33 sets when the number of rewrites of the unit cell U0 is smaller (Yes in step S354), the unit cell U0 to be in an ON-state (step S355). In contrast, the reliability control tool 33 sets. when the number of rewrites of the unit cell U1 is smaller (No in step S354), the unit cell U1 to be in an ON-state (step S356). In other words, the reliability control tool 33 rewrites a resistance state of a resistance change element included in a unit cell having a smaller number of rewrites between the unit cell U0 and the unit cell U1.

As described above, the design assistance system according to the present example embodiment assists the design of a programmable logic integrated circuit including a unit-cell pair having a configuration in which two unit cells are connected in parallel. According to the design assistance system of the present example embodiment, a probability of failing to search for a parallel signal path is reduced and thereby the reliability of a circuit to be mounted can be improved.

The design assistance system according to the present example embodiment preferentially rewrites, based on rewrite information of unit cells configuring a unit-cell pair, a unit cell having a smaller number of rewrites. Therefore, according to the design assistance system of the present example embodiment, the number of rewrites of a resistance change element included in a programmable logic integrated circuit can be equalized. When the number of rewrites of each of a plurality of resistance change elements can be equalized, the number of rewrites with respect to each resistance change element is not very different, and therefore a lifetime of each resistance change element is extended.

### Fourth Example Embodiment

Next, a design assistance system according to a fourth example embodiment of the present invention is described with reference to drawings. The design assistance system according to the present example embodiment is different form the first example embodiment in a point that configuration information including write information of a resistance change element is generated. A configuration of the design assistance system according to the present example embodiment is similar to the configuration of the first example embodiment, and therefore a description thereof is omitted. In the following description, with reference to FIG. 1, description is made by using a reference sign assigned to each of components according to the first example embodiment.

(Operation)

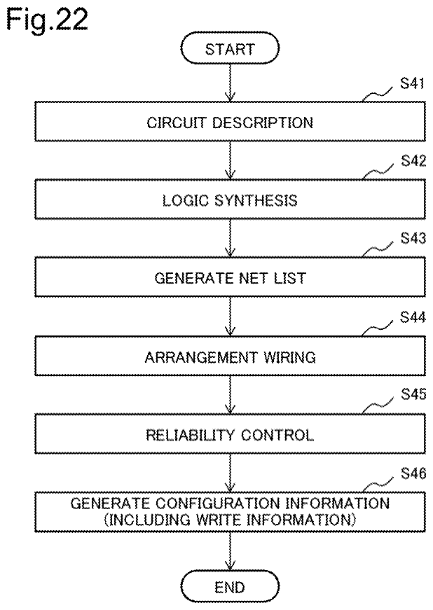

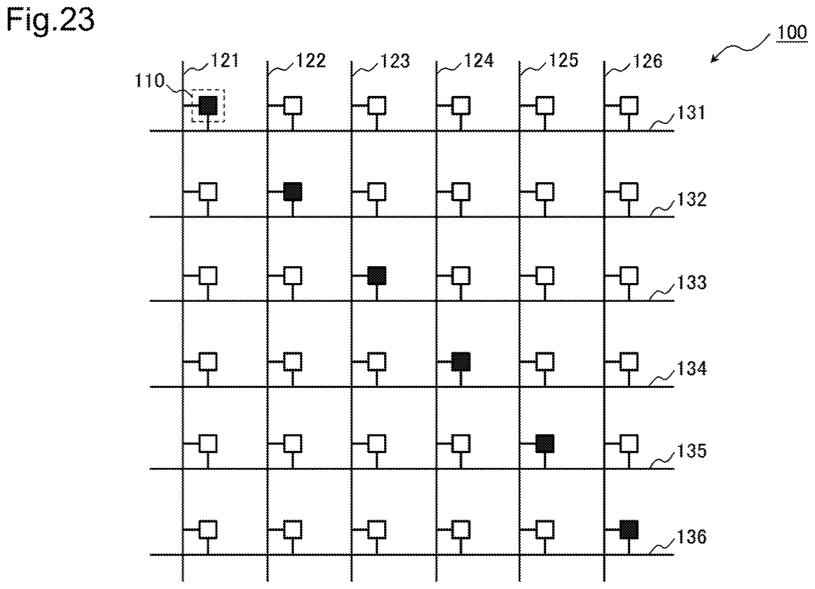

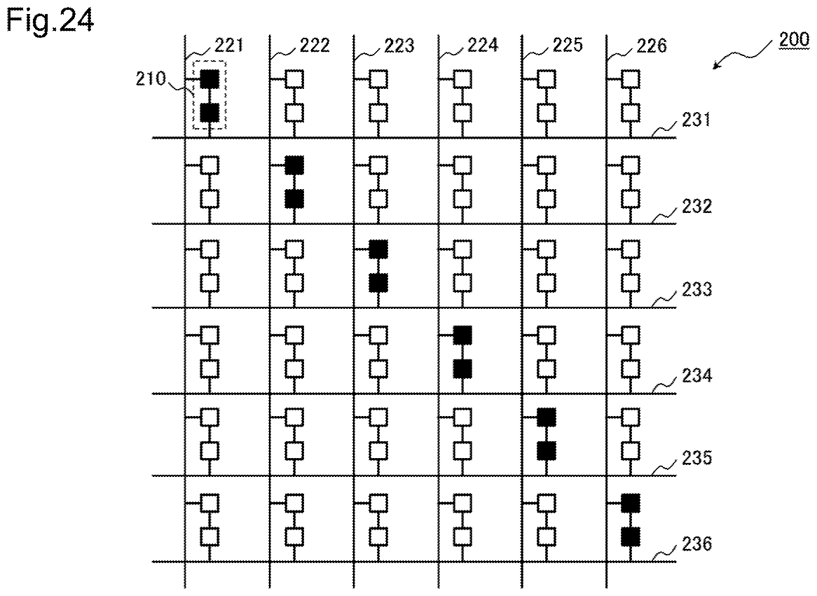

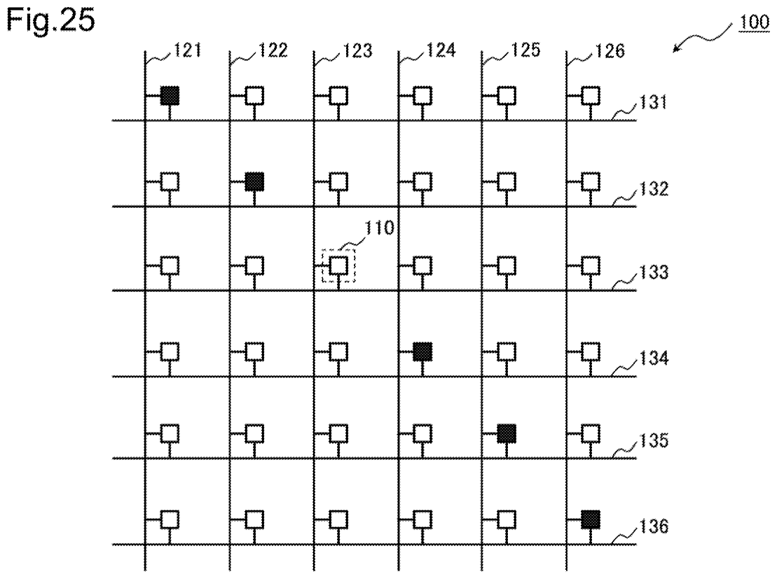

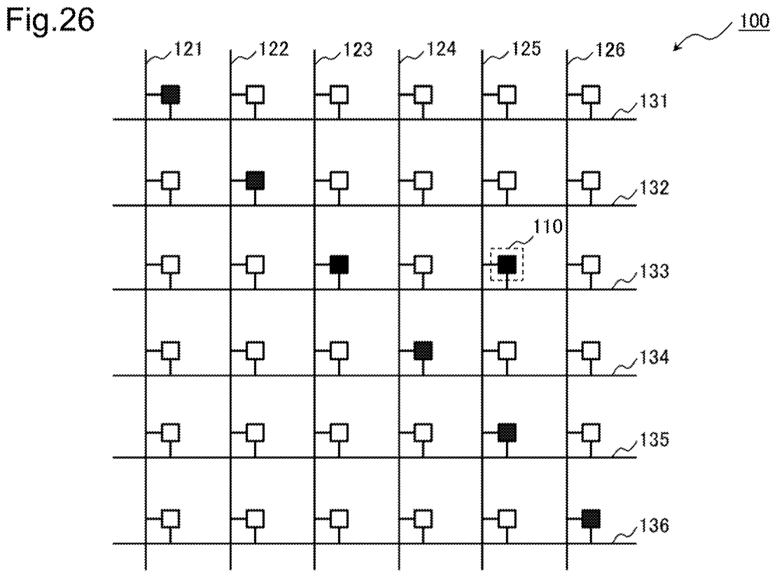

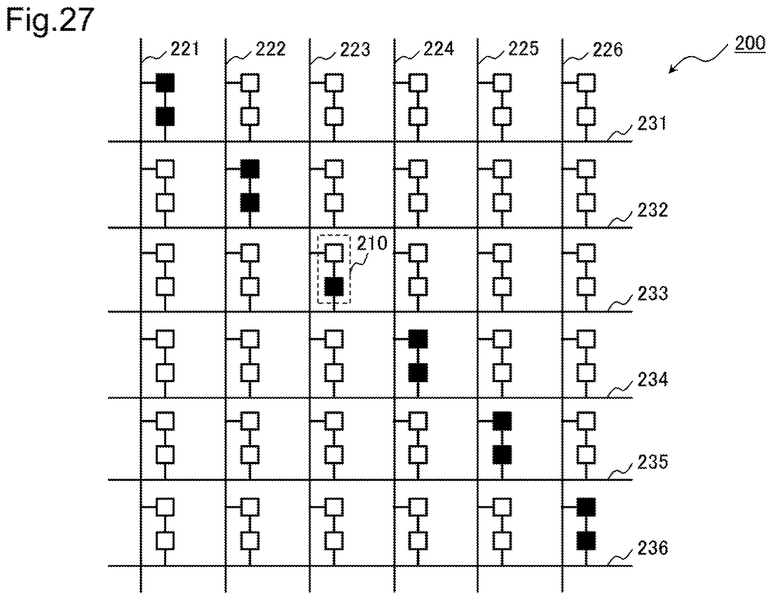

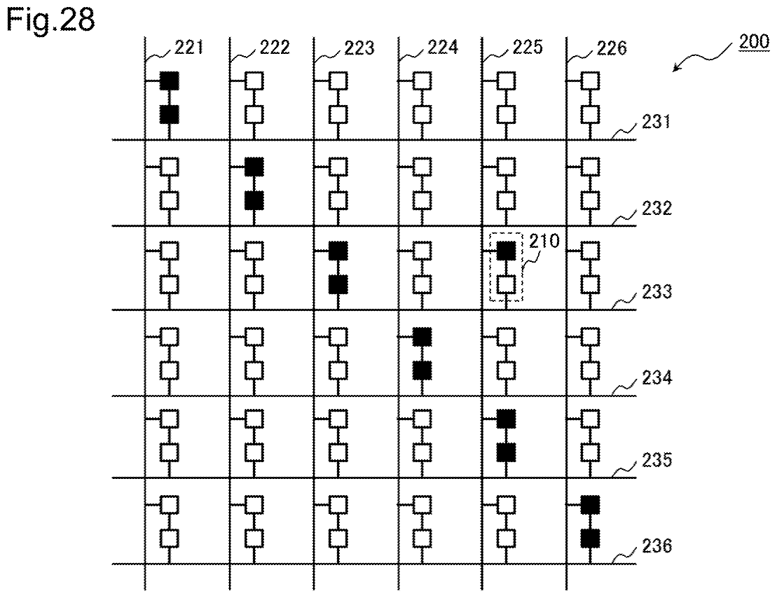

First, an operation of the design assistance system according to the present example embodiment is described with reference to a drawing. FIG. 22 is a flowchart for illustrating a design assistance method based on the design assistance system according to the present example embodiment.

Processing of steps S41 to S46 of the flowchart in FIG. 22 is related to processing of steps S11 to S16 of the flowchart in FIG. 3. The present example embodiment is different from the first example embodiment in configuration information generation processing of step S46, and other processing steps are similar to the processing steps according to the first example embodiment.

A reliability control tool 13 generates, based on a reliability mode, configuration information including, as a write condition for a resistance change element, information designating a write voltage, a write pulse width, and the number of write pulses. A reliability mode specifies a restriction condition for a probability of occurrence of a signal propagation error due to a data maintenance failure in a certain period. The reliability control tool 13 calculates, by using at least one piece of information among a type of a resource constituted of a resistance change element, a signal path, and a data maintenance failure of a resistance change element, a predicted probability of occurrence of a signal propagation error due to a data maintenance failure in a certain period. The reliability control tool 13 sets a write condition for a resistance change element in such a way as to satisfy a restriction condition for a probability of occurrence of a signal propagation error.

A failure probability of ON-state maintenance in which an ON-state is changed to an OFF-state after an elapse of a certain time after changing a resistance state and a failure probability of OFF-state maintenance in which an OFF-state is changed to an ON-state after a certain time elapses vary, depending on a write condition. As a write voltage and a pulse width are larger, a failure probability of ON-state maintenance and a failure probability of OFF-state maintenance tend to be reducible.

The reliability control tool 13 can calculate, for example, from a failure probability of ON-state maintenance of a resistance change element or a failure probability of OFF-state maintenance of a resistance change element, a false operation probability in which a normal operation is not made after a certain time elapses, with respect to each type of a resource. As examples of a resource include switch resources illustrated in FIG. 7 to FIG. 10, FIG. 18, and FIG. 19. When the memory MEMO illustrated in FIG. 10 or the memory MEMO illustrated in FIG. 19 is used as a storage portion of configuration information of an operation element, the operation element is cited as a resource.

The reliability control tool 13 can calculate a signal propagation error of a certain signal path from a false operation probability of a resource. A signal path includes a signal path illustrated in FIG. 12 and FIG. 14. The reliability control tool 13 can calculate, by using an expression represented in expression 1 and expression 2, a signal propagation error corresponding to each signal path.

The reliability control tool 13 can calculate, based on a signal propagation error of each of signal paths, a predicted probability of occurrence of a signal propagation error in an entire circuit to be mounted. The reliability control tool 13 sets a write condition for each resistance change element by repeating wiring and modifying a write condition for resistance change elements in such a way as to satisfy a restriction condition for a probability of occurrence of a signal propagation error.

As described above, the design assistance system according to the present example embodiment generates configuration information including write information designating a write voltage, a write pulse width, and the number of write pulses. Therefore, according to the design assistance system of the present example embodiment, maintenance characteristics of a mounted circuit can be optimized.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A part of a resistance change element included in a programmable logic integrated circuit may be replaced, for example, with another memory element such as an SRAM. A part of a resistance change element included in a programmable logic integrated circuit may be replaced with a circuit in which a pass transistor and another memory element such as an SRAM are combined. Description has been made by assigning each of functions (types of processing) to each component, but this assignment is not limited to the above-described assignment. Regarding components, the above-described embodiments are merely illustrative without limitation.

Processing executed by components provided in the above-described design assistance system may be executed by logic circuits each produced according to an object. It may be possible that a computer program (hereinafter, referred to as a program) describing a processing content as a procedure is recorded by a design assistance system on a readable recording medium, and the program recorded on the recording medium is read by the design assistance system and executed. As a recording medium, a movable recording medium such as a floppy (registered trademark) disk, a magneto-optical disc, a digital versatile disc (DVD), a compact disc (CD), a Blu-ray (registered trademark) disc is usable. A memory such as a read only memory (ROM), a random access memory (RAM) or a hard disc drive (HDD) included in a design assistance system may be used as a recording medium. A program recorded on a recording medium is read by a central processing unit (CPU) included in a design assistance system and is processed based on control of the CPU. The CPU operates as a computer that executes a program read from a recording medium recording the program.

Components of the design assistance system of the example embodiments according to the present invention can be optionally combined. Components of the design assistance system of the example embodiments according to the present invention may be achieved by software or may be achieved by a circuit.

The whole or part of the example embodiments disclosed above can be described as, but not limited to, the following supplementary notes.

### (Supplementary Note 1)

A design assistance system including:

a logic synthesis means that inputs an operation description file of a programmable logic integrated circuit, logically synthesizes the input operation description file and generates a net list by using logic elements included in the programmable logic integrated circuit;

an arrangement wiring means that generates resource information of the programmable logic integrated circuit, arranges, based on the generated resource information, the logic elements included in the net list, and virtually generates a signal path by wiring the arranged logic elements; and

a reliability control means that generates, based on at least two reliability modes, configuration information of the programmable logic integrated circuit and outputs the generated configuration information.

### (Supplementary Note 2)

The design assistance system according to supplementary note 1, wherein

the reliability control means

generates the configuration information of the programmable logic integrated circuit, based on a first reliability mode that allocates a wiring resource and a switch resource to a second signal path parallel to a first signal path wired by the arrangement wiring means, and a second reliability mode that does not add the signal path to the first signal path wired by the arrangement wiring means.

### (Supplementary Note 3)

The design assistance system according to supplementary note 2, wherein

the reliability control means

allocates, in the first reliability mode, the same wiring resource to the first signal path and the second signal path.

### (Supplementary Note 4)

The design assistance system according to supplementary note 2 or 3, wherein

the arrangement wiring means

searches for the signal path that minimizes an evaluation function including a delay cost based on a delay time of a wiring path, and a congestion cost based on a number of nets competing for at least either of the wiring resource and the switch resource.

### (Supplementary Note 5)

The design assistance system according to any one of supplementary notes 2 to 4, wherein

the reliability control means

sets the reliability mode for the arrangement wiring means, and

the arrangement wiring means

allocates, based on the reliability mode set by the reliability control means, either of the wiring resource and the switch resource to the first signal path and the second signal path.

### (Supplementary Note 6)

The design assistance system according to any one of supplementary notes 2 to 5, further including

a rewrite history information generation means that generates, with respect to each resistance change element, based on the configuration information read from the programmable logic integrated circuit including, as the switch resource, at least one unit cell constituted of at least two resistance change elements, rewrite history information including address information indicating a state of the resistance change element included in the programmable logic integrated circuit and rewrite number information indicating a number of rewrites of the resistance change element, wherein

the rewrite history information generation means

updates, after the configuration information generated by the reliability control means is configured in the programmable logic integrated circuit, the rewrite history information by acquiring a difference between the configuration information read from the programmable logic integrated circuit and the configuration information of a circuit already mounted on the programmable logic integrated circuit, and supplies the updated rewrite history information to the reliability control means.

### (Supplementary Note 7)

The design assistance system according to supplementary note 6, wherein

the reliability control means

preferentially rewrites, based on the rewrite history information updated by the rewrite history information generation means, the resistance change element having a smaller number of rewrites.

### (Supplementary Note 8)

The design assistance system according to any one of supplementary notes 2 to 6, wherein

the reliability control means

generates, based on the reliability mode, as a write condition for the resistance change element, the configuration information including information designating a write voltage, a write pulse width, and a number of write pulses with respect to the programmable logic integrated circuit including at least one of the switch resource constituted of at least one resistance change element.

### (Supplementary Note 9)

A design assistance method including:

logically synthesizing an operation description file of a programmable logic integrated circuit;

generating a net list by using logic elements included in the programmable logic integrated circuit;

generating resource information of the programmable logic integrated circuit;

arranging, based on the generated resource information, the logic elements included in the net list;

virtually generating a signal path by wiring the arranged logic elements;

generating, based on at least two reliability modes, configuration information of the programmable logic integrated circuit; and

outputting the generated configuration information.

### (Supplementary Note 10)

A program that causes a computer to execute:

processing of logically synthesizing an input operation description file of a programmable logic integrated circuit;

processing of generating a net list by using logic elements included in the programmable logic integrated circuit;

processing of generating resource information of the programmable logic integrated circuit;

processing of arranging, based on the generated resource information, the logic elements included in the net list;

processing of virtually generating a signal path by wiring the arranged logic elements;

processing of generating, based on at least two reliability modes, configuration information of the programmable logic integrated circuit; and

processing of outputting the generated configuration information.

### (Supplementary Note 11)

A design assistance system that assists design of a circuit to be mounted on a programmable logic integrated circuit including a resistance change element, the system including

a reliability control unit capable of setting at least two reliability modes, wherein

the reliability control unit generates, based on the reliability mode, configuration information of the circuit using the resistance change element.

### (Supplementary Note 12)

The design assistance system according to supplementary note 11, wherein

the circuit has first connection information,

when, as the reliability mode, a first reliability mode is set,

the reliability control unit manages, based on the first connection information, allocation of a wiring resource and a switch resource of the programmable logic integrated circuit to a first signal path and a second signal path, and

the first signal path and the second signal path are electrically parallel.

### (Supplementary Note 13)

The design assistance system according to supplementary note 12, wherein the reliability control unit includes a function of allocating a same wiring resource to the first signal path and the second signal path.

### (Supplementary Note 14)

The design assistance system according to supplementary note 12 or 13, further including

a wiring unit that allocates a wiring resource and a switch resource, wherein

the reliability control unit instructs the wiring unit to allocate a wiring resource and a switch resource to the first signal path and the second signal path.

### (Supplementary Note 15)

The design assistance system according to any one of supplementary notes 12 to 14, wherein

the switch resource includes a unit cell,

the unit cell includes a first terminal and a second terminal,

the unit cell is constituted of one resistance change element or two or more resistance change elements connected in series, and

configuration information of the circuit using the switch resource is generated.

### (Supplementary Note 16)

The design assistance system according to any one of supplementary notes 12 to 15, wherein

the switch resource includes a transistor and a memory,

the transistor includes a source terminal, a drain terminal, and a gate terminal,

the gate terminal is connected to an output terminal of the memory, and

configuration information of the circuit using the switch resource is generated.

### (Supplementary Note 17)

The design assistance system according to any one of supplementary notes 12 to 16, wherein

the switch resource includes a first unit cell and a second unit cell,

the first unit cell includes a first terminal and a second terminal,

the first terminal is constituted of one resistance change element or two or more resistance change elements connected in series,

the second unit cell includes a third terminal and a fourth terminal,

the second unit cell is constituted of one resistance change element or two or more resistance change elements connected in series,

the first terminal and the third terminal are connected,

the second terminal and the fourth terminal are connected, and

configuration information of the circuit using the switch resource is generated.

### (Supplementary Note 18)

The design assistance system according to any one of supplementary notes 12 to 17, further including

a rewrite history information generation unit that generates rewrite history information indicating a number of modifications of a state of the resistance change element, wherein,

when, as the reliability mode, a second reliability mode is set,

the reliability control unit sets, based on the rewrite history information, a resistance change element included in either of a first unit cell and a second unit cell among the allocated switch resource to be in an ON-state.

### (Supplementary Note 19)

The design assistance system according to any one of supplementary notes 11 to 18, wherein

the reliability control unit generates, as a write condition for the resistance change element, configuration information including information designating a write voltage, a write pulse width, and a number of write pulses,

the reliability mode specifies a restriction condition for a probability of occurrence of a signal propagation error due to a data maintenance failure in a certain period, and

the reliability control unit calculates, from at least one piece of information among a type of a resource constituted of the resistance change element, a signal path, and a data maintenance failure of a resistance change element, a predicted probability of occurrence of a signal propagation error due to a data maintenance failure in a certain period and determines the write condition in such a way as to satisfy a restriction condition for a probability of occurrence of the signal propagation error.

### (Supplementary Note 20)

A design assistance method of assisting design of a circuit to be mounted on a programmable logic integrated circuit including a resistance change element, the method including:

processing of setting at least two reliability modes;

processing of generating, based on the reliability mode, configuration information of the circuit,

the circuit having first connection information; and

processing of managing, when as the reliability mode, a first reliability mode is set,

allocation of a wiring resource and a switch resource of the programmable logic integrated circuit to a first signal path and a second signal path, based on the first connection information, wherein

the first signal path and the second signal path are electrically parallel.

This application is based upon and claims the benefit of priority from Japanese patent application No. 2017-228490, filed on Nov. 29, 2017, the disclosure of which is incorporated herein in its entirety by reference.

### REFERENCE SIGNS LIST

1 Design assistance system
2 Configuration information transfer device
3 Programmable logic integrated circuit
10, 30 Design assistance tool group
11, 31 Logic synthesis tool
12, 32 Arrangement wiring tool
13, 33 Reliability control tool
34 Rewrite history information generation tool
101 Operation device
102 Storage device
103 Display device
104 Input/output device
105 Bus
311, 312, 313, 314, 315, 331, 332 Switch resource

What is claimed is:

1. A design assistance system comprising:
at least one memory storing instructions; and
at least one processor connected to the at least one memory and configured to execute the instructions to:
input an operation description file of a programmable logic integrated circuit;
logically synthesize the input operation description file;
generate a net list by using logic elements included in the programmable logic integrated circuit;
generate resource information of the programmable logic integrated circuit;
arrange, based on the generated resource information, the logic elements included in the net list;
virtually generate a signal path by wiring the arranged logic elements; and
generate, based on at least two reliability modes, configuration information of the programmable logic integrated circuit and output the generated configuration information.

2. The design assistance system according to claim 1, wherein
the at least one processor is configured to execute the instructions to
generate the configuration information of the programmable logic integrated circuit, based on a first reliability mode that allocates a wiring resource and a switch resource to a second signal path parallel to a first signal path, and a second reliability mode that does not add the signal path to the first signal path.

3. The design assistance system according to claim 2, wherein
the at least one processor is configured to execute the instructions to
allocate, in the first reliability mode, the same wiring resource to the first signal path and the second signal path.

4. The design assistance system according to claim 2, wherein
the at least one processor is configured to execute the instructions to
search for the signal path that minimizes an evaluation function including a delay cost based on a delay time of a wiring path, and a congestion cost based on a number of nets competing for at least either of the wiring resource and the switch resource.

5. The design assistance system according to claim 2, wherein
the at least one processor is configured to execute the instructions to:
set the reliability mode; and
allocate, based on the set reliability mode, either of the wiring resource and the switch resource to the first signal path and the second signal path.

6. The design assistance system according to claim 2, wherein
the at least one processor is configured to execute the instructions to:
regenerate, with respect to each resistance change element, based on the configuration information read from the programmable logic integrated circuit including, as the switch resource, at least one unit cell constituted of at least two resistance change elements;
rewrite history information including address information indicating a state of the resistance change element included in the programmable logic integrated circuit and rewrite number information indicating a number of rewrites of the resistance change element; and
update, after the generated configuration information is configured in the programmable logic integrated circuit, the rewrite history information by acquiring a difference between the configuration information read from the programmable logic integrated circuit and the configuration information of a circuit already mounted on the programmable logic integrated circuit.

7. The design assistance system according to claim 6, wherein
the at least one processor is configured to execute the instructions to
preferentially rewrite, based on the updated rewrite history information, the resistance change element having a smaller number of rewrites.

8. The design assistance system according to claim 2, wherein
the at least one processor is configured to execute the instructions to
generate, based on the reliability mode, as a write condition for the resistance change element, the configuration information including information designating a write voltage, a write pulse width, and a number of write pulses with respect to the programmable logic integrated circuit including at least one of the switch resource constituted of at least one resistance change element.

9. A design assistance method by a computer, the method comprising:
logically synthesizing an operation description file of a programmable logic integrated circuit;
generating a net list by using logic elements included in the programmable logic integrated circuit;
generating resource information of the programmable logic integrated circuit;
arranging, based on the generated resource information, the logic elements included in the net list;
virtually generating a signal path by wiring the arranged logic elements;
generating, based on at least two reliability modes, configuration information of the programmable logic integrated circuit; and
outputting the generated configuration information.

10. A non-transitory program recording medium recording a program that causes a computer to execute:
processing of logically synthesizing an input operation description file of a programmable logic integrated circuit;
processing of generating a net list by using logic elements included in the programmable logic integrated circuit;
processing of generating resource information of the programmable logic integrated circuit;
processing of arranging, based on the generated resource information, the logic elements included in the net list;
processing of virtually generating a signal path by wiring the arranged logic elements;
processing of generating, based on at least two reliability modes, configuration information of the programmable logic integrated circuit; and
processing of outputting the generated configuration information.

11-20. (canceled)
